(19) United States
(12) Patent Application Publication
(10) Pub. No.: US 2014/0104875 A1
(43) Pub. Date: Apr. 17, 2014

(54) BACKLIGHT MODULE

(71) Applicants: Gang Yu, Shenzhen City (CN); Yubo Gu, Shenzhen City (CN); Liuyang Yang, Shenzhen City (CN)

(72) Inventors: Gang Yu, Shenzhen City (CN); Yubo Gu, Shenzhen City (CN); Liuyang Yang, Shenzhen City (CN)

(73) Assignee: Shenzhen China Star Optoelectronics Technology Co. Ltd., Shenzhen, Guangdong (CN)

(21) Appl. No.: 13/704,235

(22) PCT Filed: Oct. 26, 2012
(86) PCT No.: PCT/CN12/83527

§ 371 Date: Dec. 13, 2012

(30) Foreign Application Priority Data
Oct. 12, 2012 (CN) 201210387514.8

(51) Int. Cl. F21V 21/00

(52) U.S. Cl. CPC F21V 21/00
USPC 362/609

(57) ABSTRACT

The present invention provides a backlight module, which includes a backplane, a light source arranged inside the backplane, a reflector plate arranged inside the backplane, a light guide plate arranged on the reflector plate, and a mold frame mounted to the backplane. The light source is connected by an electrical wire to an external circuit. The backplane forms a carrier section that carries the electrical wire. The mold frame forms a receiving channel corresponding to the location of the electrical wire. The electrical wire is positioned between the carrier section and the receiving channel. The backlight module includes a backplane forming a carrier section and a mold frame forming a receiving channel so that an electrical wire is positioned between the carrier section and the receiving channel to prevent the problem of damage of a light source caused by mounting the electrical wire that is found in the known techniques.

### BACKGROUND OF THE INVENTION

1. Field of the Invention

The present invention relates to the field of liquid crystal displaying, and in particular to a backlight module.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The operation principle of the liquid crystal panel is that liquid crystal molecules are interposed between two parallel glass substrates and a plurality of vertical and horizontal fine electrical wires are arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module comprises a light source, such as a cold cathode fluorescent lamp (CCFL) or a light-emitting diode (LED), which is arranged at the back side of the liquid crystal panel to form a planar light source that directly provides lighting to the liquid crystal panel. The side-edge backlight module comprises a backlight source of LED light bar arranged at an edge of a backplane to be located rearward of one side of the liquid crystal panel. The LED light bar emits light that enters a light guide plate (LGP) through a light incident face of the light guide plate and is projected out through a light emergence face of the light guide plate, after being reflected and diffused, to thereby transmit through an optic film assembly and form a planar light source for the liquid crystal panel.

Referring to FIGS. 1 and 2, schematic views are given to show a conventional backlight module comprising a CCFL (Cold Cathode Fluorescent Lamp) light source and mounting position of electrical wire. The backlight module comprises a backplane 100, a linear light source 300 arranged inside the backplane 100, a reflector plate 500 arranged inside the backplane 100, a light guide plate 700 arranged above the reflector plate 500, an optic film assembly 900 arranged on the light guide plate 700, and a mold frame 950 mounted to the backplane 100. An electrical wire 302 connecting the linear light source 300 and an external circuit is mounted in a slit 952. The slit 952 is formed in the mold frame 950 at a location close to the linear light source 300. Since the slit 952 is close to the linear light source 300, the force acting on the mold frame 950 in fixing the electrical wire 302 might cause deformation of the mold frame 950 and compressing the liner light source 300. This may result in damage of the linear light source 300 and cause failure of the backlight module in supplying a planar light source.

### SUMMARY OF THE INVENTION

An object of the present invention is to provide a backlight module, which comprises a backplane and a mold frame that are assembled and fixed together through snap-fitting connection, showing a simple structure and being easy to assemble and disassemble.

To achieve the object, the present invention provides a backlight module, which comprises a backplane, a light source arranged inside the backplane, a reflector plate arranged inside the backplane, a light guide plate arranged on the reflector plate, and a mold frame mounted to the backplane. The light source is connected by an electrical wire to an external circuit. The backplane forms a carrier section that carries the electrical wire. The mold frame forms a receiving channel corresponding to the location of the electrical wire. The electrical wire is positioned between the carrier section and the receiving channel.

The backplane comprises a bottom board and a first side board connected to the bottom board.

The carrier section is formed on the first side board.

The carrier section comprises a double-sided adhesive tape attached thereto. The electrical wire is attached to the carrier section by the double-sided adhesive tape.

The mold frame comprises a top board and a second side board connected to the top board.

The retention slot is formed in the second side board.

The backplane forms a pawl section and the mold frame forms a retention slot corresponding to the pawl section. The pawl section is receivable in and retained in the retention slot.

The pawl section is formed on the first side wall. The retention slot is formed in the second side wall. The pawl section extends downward in an inclined manner from an outside surface of the first side board at a location adjacent to a free end thereof and has an inclined face. The inclined face is arranged to face toward the retention slot.

The backlight module further comprises a heat dissipation plate arranged under the reflector plate, a diffusion plate arranged on the light guide plate, and a prism plate arranged on the diffusion plate.

The light source comprises a linear light source of CCFL.

The present invention also provides a backlight module, which comprises a backplane, a light source arranged inside the backplane, a reflector plate arranged inside the backplane, a light guide plate arranged on the reflector plate, and a mold frame mounted to the backplane, the light source being connected by an electrical wire to an external circuit, the backplane forming a carrier section that carries the electrical wire, the mold frame forming a receiving channel corresponding to the location of the electrical wire, the electrical wire being positioned between the carrier section and the receiving channel;

wherein the backplane comprises a bottom board and a first side board connected to the bottom board;

wherein the carrier section is formed on the first side board;

wherein the carrier section comprises a double-sided adhesive tape attached thereto, the electrical wire being attached to the carrier section by the double-sided adhesive tape;

wherein the mold frame comprises a top board and a second side board connected to the top board;

wherein the retention slot is formed in the second side board;

wherein the backplane forms a pawl section and the mold frame forms a retention slot corresponding to the pawl section, the pawl section being receivable in and retained in the retention slot;

wherein the pawl section is formed on the first side wall, the retention slot being formed in the second side wall, the pawl section extending downward in an inclined manner from an outside surface of the first side board at a location adjacent to a free end thereof and has an inclined face, the inclined face being arranged to face toward the retention slot;

further comprising a heat dissipation plate arranged under the reflector plate, a diffusion plate arranged on the light guide plate, and a prism plate arranged on the diffusion plate; and

wherein the light source comprises a linear light source of CCFL.

The efficacy of the present invention is that the present invention provides a backlight module, which comprises a backplane forming a carrier section and a mold frame forming a receiving channel. An electrical wire is positioned between the carrier section and the receiving channel to prevent the problem of damage of a light source caused by mounting the electrical wire that is found in the known techniques thereby effectively ensure intactness of the light source and thus ensure the quality of the backlight module. Further, the backplane and the mold frame according to the present invention are connected through snap fitting so that assembling and disassembling are easy, time is saved, the manufacturing cost is reduced.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawing. In the drawing:

FIG. 1 is a schematic view showing the structure of a conventional backlight module comprising a CCFL light source;

FIG. 2 is a schematic view showing mounting position of an electrical wire of the CCFL light source; and

FIG. 3 is a schematic view showing the structure of a backlight module according to the present invention.

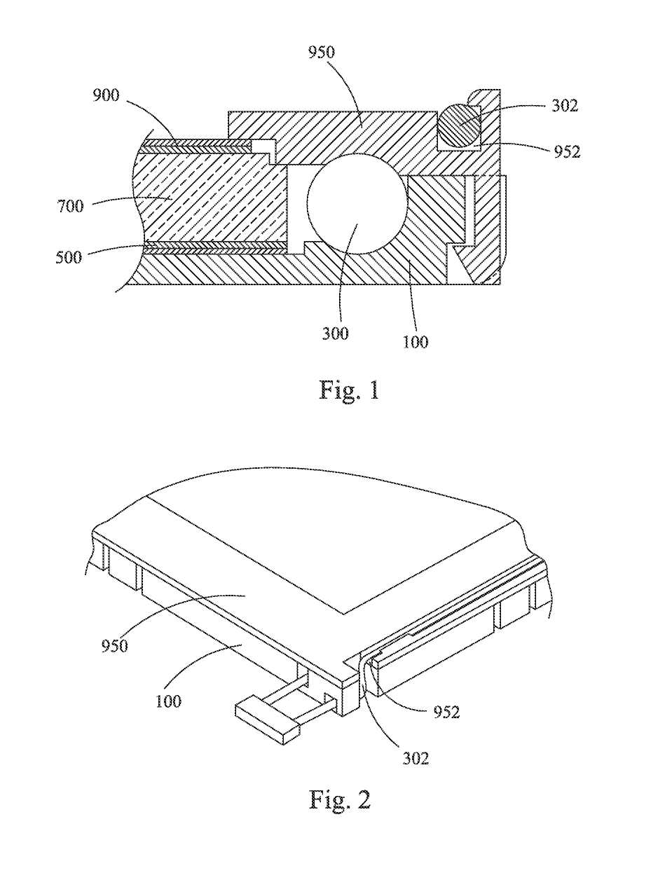

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

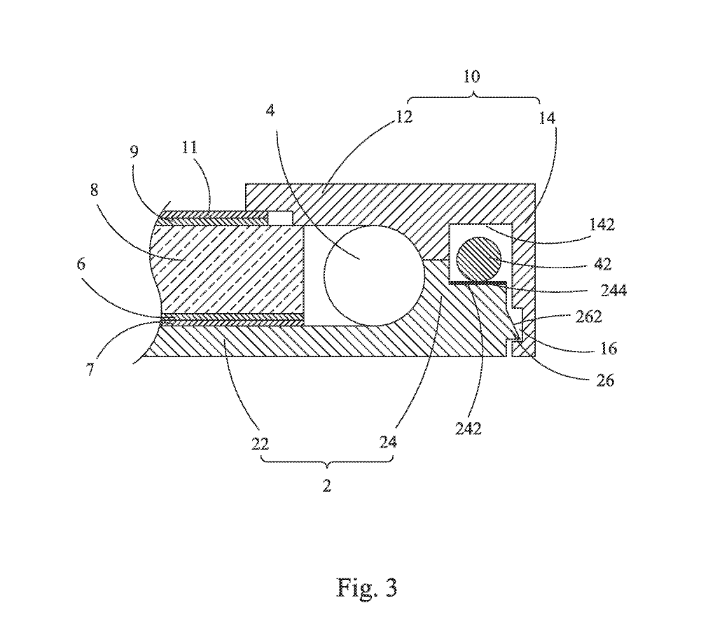

Referring to FIG. 3, the present invention provides a backlight module, which comprises a backplane 2, a light source 4 arranged inside the backplane 2, a reflector plate 6 arranged inside the backplane 2, a light guide plate 8 arranged on the reflector plate 6, and a mold frame 10 mounted to the backplane 2.

The light source 4 is connected to an external circuit (not shown) by an electrical wire 42. The backplane 2 comprises a bottom board 22 and a first side board 24 connected to the bottom board 22. The backplane 2 forms a carrier section 242 that carries the electrical wire 42. Preferably, the carrier section 242 is formed on the first side board 24. The mold frame 10 comprises a top board 12 and a second side board 14 connected to the top board 12. The mold frame 10 forms a receiving channel 142 corresponding to the location of the electrical wire 42. Preferably, the receiving channel 142 is formed in the second side board 14 corresponding to the carrier section 242. The electrical wire 42 is positioned between the carrier section 242 and the receiving channel 142.

In the instant embodiment, the carrier section 242 is formed on a free end of the first side board 24 and is a recess that has openings in both top face and a lateral face. The carrier section 242 comprises a double-sided adhesive tape 44 attached thereto. The electrical wire 42 is adhesively attached to the carrier section 242 by the double-sided adhesive tape 244 so as to make it difficult for the electrical wire 42 to shift in position. Further, the double-sided adhesive tape 244 is preferably a double-sided adhesive tape having low adhesion for easy removal. To fix the electrical wire 42, the electrical wire 42 is positioned on the carrier section 242 formed on the first side board 24 of the backplane 2 and a slight force is applied to have the double-sided adhesive tape 244 adhering the electrical wire 42. The force acts on the backplane 2 in a downward direction without compressing the light source 4 so as to ensure the intactness of the light source 4.

The backplane 2 forms a pawl section 26. The mold frame 10 forms a retention slot 16 corresponding to the pawl section 26. The pawl section 26 is received in and retained by the retention slot 16 so as to have the mold frame 10 and the backplane 20 assembled together.

Preferably, the pawl section 26 is formed on the first side board 24. The retention slot 16 is formed in the second side board 14. The pawl section 26 is formed to extend downward in an inclined manner from an outside surface of the first side board 24 at a location adjacent to a free end thereof and has an inclined face 262. The inclined face 262 is arranged to face toward the retention slot 16. To assemble, the mold frame 10 is directly pressed down toward the backplane 2 to have the pawl section 26 sliding into the retention slot 16. The process of mounting is simple and time can be saved. To disassemble, a free end of the second side board 14 of the mold frame 10 is deflected outward, and at the same time, the mold frame 10 is lifted upward to allow the pawl section 26 to slide off the retention slot 16 thereby separating the mold frame 10 and the backplane 2 from each other. The processing of disassembling is simple and time can be saved.

The backlight module according to the present invention also comprises a heat dissipation plate 7 arranged under the reflector plate 6, a diffusion plate 9 arranged on the light guide plate 8, and a prism plate 11 arranged on the diffusion plate 9. The light source 5 comprises a linear light source of CCFL, which emits light of which a portion transmits through an incidence surface of the light guide plate 8 to directly enter the interior of the light guide plate 8 and a remaining portion is reflected by the reflector plate 6 to get into the light guide plate 8. The light propagates through the light guide plate 8 as being simultaneously subjected to total reflection and refraction and is further subjected to diffusion through the diffusion plate 9 and the prism plate 11 to thereby provide a uniformly distributed planar light source.

In summary, the present invention provides a backlight module, which comprises a backplane forming a carrier section and a mold frame forming a receiving channel. An electrical wire is positioned between the carrier section and the receiving channel to prevent the problem of damage of a light source caused by mounting the electrical wire that is found in the known techniques thereby effectively ensure intactness of the light source and thus ensure the quality of the backlight module. Further, the backplane and the mold frame according to the present invention are connected through snap fitting so that assembling and disassembling are easy, time is saved, the manufacturing cost is reduced.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising a backplane, a light source arranged inside the backplane, a reflector plate arranged inside the backplane, a light guide plate arranged on the reflector plate, and a mold frame mounted to the backplane, the light source being connected by an electrical wire to an external circuit, the backplane forming a carrier section that carries the electrical wire, the mold frame forming a receiving channel corresponding to the location of the electrical wire, the electrical wire being positioned between the carrier section and the receiving channel.

2. The backlight module as claimed in claim 1, wherein the backplane comprises a bottom board and a first side board connected to the bottom board.

3. The backlight module as claimed in claim 2, wherein the carrier section is formed on the first side board.

4. The backlight module as claimed in claim 3, wherein the carrier section comprises a double-sided adhesive tape attached thereto, the electrical wire being attached to the carrier section by the double-sided adhesive tape.

5. The backlight module as claimed in claim 1, wherein the mold frame comprises a top board and a second side board connected to the top board.

6. The backlight module as claimed in claim 5, wherein the retention slot is formed in the second side board.

7. The backlight module as claimed in claim 6, wherein the backplane forms a pawl section and the mold frame forms a retention slot corresponding to the pawl section, the pawl section being receivable in and retained in the retention slot.

8. The backlight module as claimed in claim 7, wherein the pawl section is formed on the first side wall, the retention slot being formed in the second side wall, the pawl section extending downward in an inclined manner from an outside surface of the first side board at a location adjacent to a free end thereof and has an inclined face, the inclined face being arranged to face toward the retention slot.

9. The backlight module as claimed in claim 1 further comprising a heat dissipation plate arranged under the reflector plate, a diffusion plate arranged on the light guide plate, and a prism plate arranged on the diffusion plate.

10. The backlight module as claimed in claim 1, wherein the light source comprises a linear light source of CCFL.

11. A backlight module, comprising a backplane, a light source arranged inside the backplane, a reflector plate arranged inside the backplane, a light guide plate arranged on the reflector plate, and a mold frame mounted to the backplane, the light source being connected by an electrical wire to an external circuit, the backplane forming a carrier section that carries the electrical wire, the mold frame forming a receiving channel corresponding to the location of the electrical wire, the electrical wire being positioned between the carrier section and the receiving channel;
wherein the backplane comprises a bottom board and a first side board connected to the bottom board;
wherein the carrier section is formed on the first side board;
wherein the carrier section comprises a double-sided adhesive tape attached thereto, the electrical wire being attached to the carrier section by the double-sided adhesive tape;
wherein the mold frame comprises a top board and a second side board connected to the top board;
wherein the retention slot is formed in the second side board;
wherein the backplane forms a pawl section and the mold frame forms a retention slot corresponding to the pawl section, the pawl section being receivable in and retained in the retention slot;
wherein the pawl section is formed on the first side wall, the retention slot being formed in the second side wall, the pawl section extending downward in an inclined manner from an outside surface of the first side board at a location adjacent to a free end thereof and has an inclined face, the inclined face being arranged to face toward the retention slot;
further comprising a heat dissipation plate arranged under the reflector plate, a diffusion plate arranged on the light guide plate, and a prism plate arranged on the diffusion plate; and
wherein the light source comprises a linear light source of CCFL.
